(19) United States
(12) Patent Application Publication
(10) Pub. No.: US 2009/0172990 A1
(43) Pub. Date: Jul. 9, 2009

(54) MARKABLE LABEL AND METHOD OF MANUFACTURE

(76) Inventor: Bethann Corey, Redlands, CA (US)

Correspondence Address: STETINA BRUNDA GARRED & BRUCKER, 75 ENTERPRISE, SUITE 250, ALISO VIEJO, CA, 92656, US

(21) Appl. No.: 12/348,081

(22) Filed: Jan. 2, 2009

Related U.S. Application Data
(60) Provisional application No. 61/010,016, filed on Jan. 4, 2008.

(51) Int. Cl. G09F 3/02; B32B 37/00; B32B 3/04

(52) U.S. Cl. 40/675; 156/277; 156/290; 156/216

(57) ABSTRACT

The present invention relates to a layered container label that can be marked by the consumer without the aid of a writing device, as well as the method and manufacturing such label. The markable label is formed in layers with: an upper translucent film; a base layer having visually contrasting regions; and an intermediate deformable covering material such as wax laminated between the upper translucent film and the contrasting base layer. Upon application of pressure to the exposed surface of the upper layer, the intermediate deformable covering material is disrupted to visually expose the contrasting region of the base film layer at the point of applied pressure. This allows a user to mark the label without any writing implements. The present invention additionally includes methods of producing the label including providing: an upper layer of translucent film; a base layer web film with color contrasting regions; spot gluing upon the upper layer; coating the base layer with wax over the visually contrasting regions; and pressing the two treated films to form the label of the present invention. A second method includes: applying the darker region to a single piece of film; applying a wax coating over the darkened region; applying adhesive material to the perimeter of the wax material and folding the film to laminate the wax material between the pieces of folded film.

### CROSS-REFERENCE TO RELATED APPLICATIONS

This application claims the benefits of U.S. Provisional Patent Application Ser. No. 61/010,016, filed on Jan. 4, 2008, the entire contents of which is incorporated herein by reference.

### STATEMENT RE: FEDERALLY SPONSORED RESEARCH/DEVELOPMENT

Not Applicable

### BACKGROUND

The present invention relates generally to a container label structure and the method of manufacturing the same. More particularly, the present invention comprises a layered container label that can be marked by a consumer without the aid of a writing device as well as methods of manufacturing such label.

Consumers purchase beverages in a wide variety of containers wherein the containers include manufacturing labeling. Many times the beverages are consumed directly from the container and as labeling on the containers are typically identical for a beverage emanating from a single manufacturer consumers may have difficulty in distinguishing partially consumed drink containers. This results in waste as the consumer may select a new beverage rather than using the partially consumed beverage, or alternatively, the resulting confusion between the containers can result in the consumer being exposed to unwanted viruses and bacteria should they chose the wrong container.

Previously, labels have included a thin scratchable surface as exemplified in U.S. Pat. No. 5,154,448 which, are similar to the “scratch-off” lottery tickets. Such prior art devices produce “scratch-off” residue or flaking and require additional steps in the labeling manufacturing process. Accordingly, there is a need in the art for a label marking system that can be utilized by the consumer without the need for the use of a writing instrument, and which is integral with the label to allow for ease in the manufacturing process in which additionally avoids any residue created by the marking system. The device and method of the present invention addresses these particular needs, as is discussed in more detail below.

### BRIEF SUMMARY

The present invention relates to a multilayer container label and method of manufacturing that can be attached to a container that allows the consumer to mark the label without the aid of a writing device.

The label of the present invention may be applied to a beverage container and includes a markable region. The markable region includes a top translucent layer, an intermediate layer comprising a deformable covering such as a wax and a base layer having a contrasting color with such base layer being adhesively attached to the upper layer. The resulting label provides the upper layer in laminate juxtaposition to the intermediate wax layer and the lower colored base layer. In operation, pressure is applied to the outer surface of the top translucent layer thereby disrupting the deformable wax material causing the upper film to contact or expose the colored base layer thereby creating a visually contrasting area at the point of applied pressure. As such, the user by applying a finger or fingernail can apply pressure to the marking area to provide identifying information to allow the consumer to identify a container or alternatively to expose information imprinted on the base layer, for example variable digital images for use on applications such as game pieces.

The above-identified laminated structure of the present invention can additionally be applied to a pressure sensitive adhesive and release liner such that the user can peel away the release liner and apply the pressure sensitive adhesive to an accommodating surface. It is contemplated that the label of the present invention, with the pressure sensitive adhesive and release liner could be applied to a beverage container or any number of useful surfaces.

The laminate label structure of the present invention as described herein may be produced by alternative methods of manufacture. A first method comprises: providing an upper layer of web translucent film; spot gluing a pattern to the inner surface of the upper layer web of film; providing a base layer web of film; printing a visually contrasting region upon the base layer film; spot coating the contrasting regions of the base layer film with deformable substance such as wax; placing the treated upper layer and lower layer film against each other; and pressing the layers to permanently affix the layers with the adhesive. In a modification to the first method of manufacture, the step of spot gluing can be applied directly on the base layer web of film. Also, in a further modification, the step of spot gluing may be eliminated where the upper web of film and the base layer of film are formed from material that is capable of forming a cohesive or static bond when placed in contact and thus an adhesive is not required. An alternate method of manufacture includes: providing a single web of translucent film; including a region which is printed or treated to create a visually contrasting region; coating the visually contrasting region with a deformable substance such as wax; applying a spot adhesive to areas immediately adjacent to the deformable wax material; and folding the film such that the inner surface of the film contacts the adhesive to provide the laminate structure of the label of the present invention. In this regard, the deformable wax material is sandwiched between the folded layers of the film. In a modification of the of the alternative method of manufacture, the step of applying a spot adhesive may be eliminated where the single web of film is formed from material that forms a cohesive or static bond when the material is folded and two surfaces of the film contact each other and thus an adhesive bond is not required.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an example of a container employing the label device of the present invention;

FIG. 2 is the container of FIG. 1 employing the invention of the present invention with the user marking the label with a finger;

FIG. 3 is a top plan view of the label of the present invention;

FIG. 4 is a cross-sectional view of the label shown in FIG. 3;

FIG. 5 is an exploded view of the layer of the label of the present invention as shown in FIG. 4;

FIG. 6 is a diagram of a process of manufacturing the label of the present invention;

FIG. 7 is a top plan view of the label of the present invention configured in an alternate embodiment;

FIG. 8 is a cross-sectional view of the alternate embodiment of the label of FIG. 7;

FIG. 9 is a diagram of the method of manufacturing the alternate embodiment of the present invention as shown in FIGS. 7 and 8;

FIG. 10 is the top plan view of the label of the present invention being applied to a pressure sensitive adhesive with removable backing;

FIG. 11 is an exploded view of the label applied to a pressure sensitive adhesive and backing as shown in FIG. 10;

FIG. 12 is a further embodiment of a method of manufacturing of the label of the present invention;

FIG. 13 is a further embodiment of a method of producing the label of the present invention.

### DETAILED DESCRIPTION

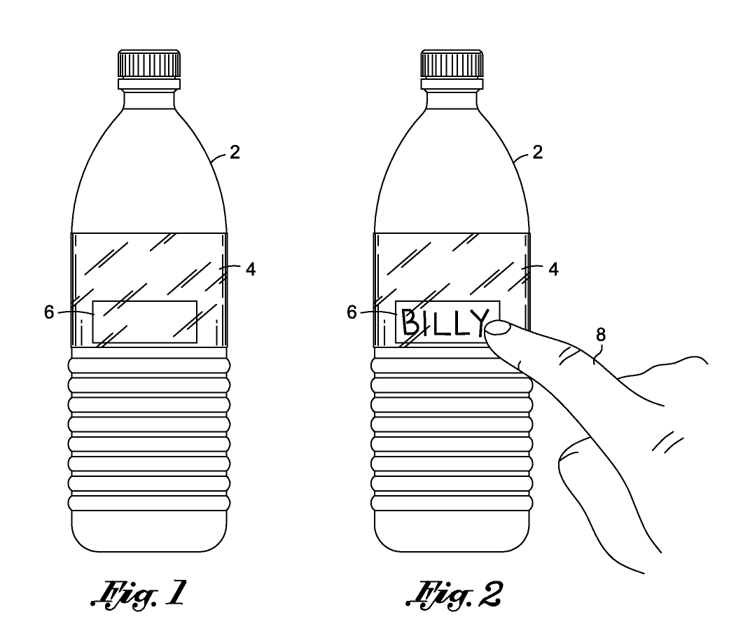

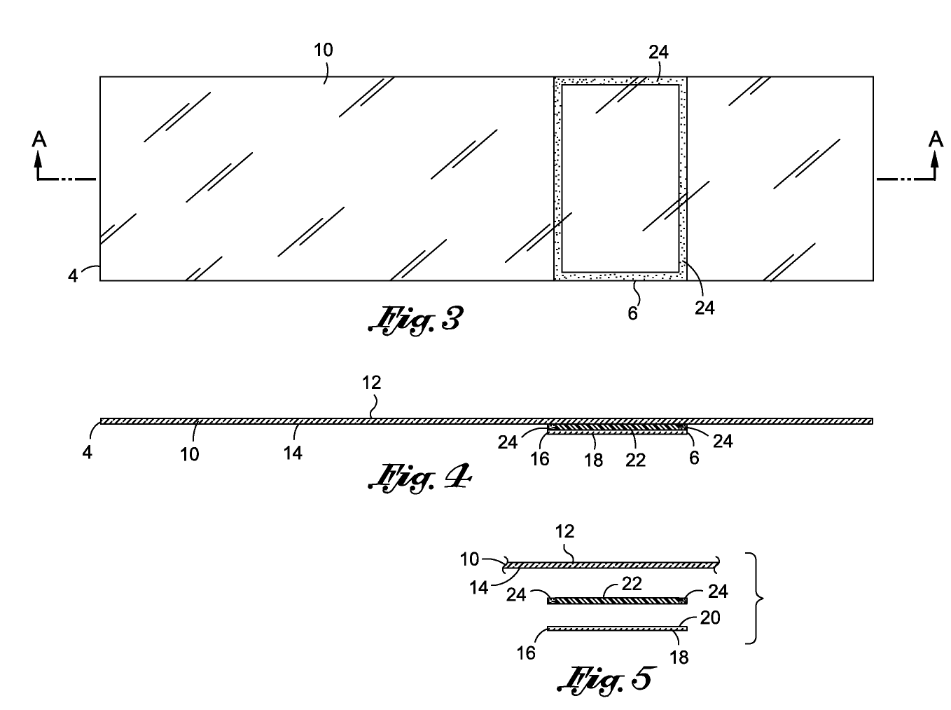

Referring particularly to FIGS. 1 and 2 the label of the present invention 4 is shown on an exemplary beverage container 2. The label 4 of the present invention allows a user to embellish the label 4 of the present invention already fixed to a container 2 without the need for a writing instrument. The label 4 includes a markable region 6 which allows a user to apply a finger 8 fingernail, key or other hard implement to the markable region 6 to inscribe information upon the label.

The label 4 permits a user to apply information to the bottle without the need for the use of a writing implement, and without the user encountering undesirable residues, flaking or marking inks which can discolor hands or clothing. The label device for the present invention is a significant improvement in the art as the marking appears beneath the surface of a translucent layer of the marking region 6 and as such, is completely contained within the label.

Although the label 4 of the present invention is suited for use with a water bottle container, it is additionally contemplated that the beverage container can be a juice box, plastic cup, glass bottle, plastic juice container or milk carton. The foregoing types of beverage containers are exemplary and not limiting as the label 4 can be applied to many disposable containers or vessels.

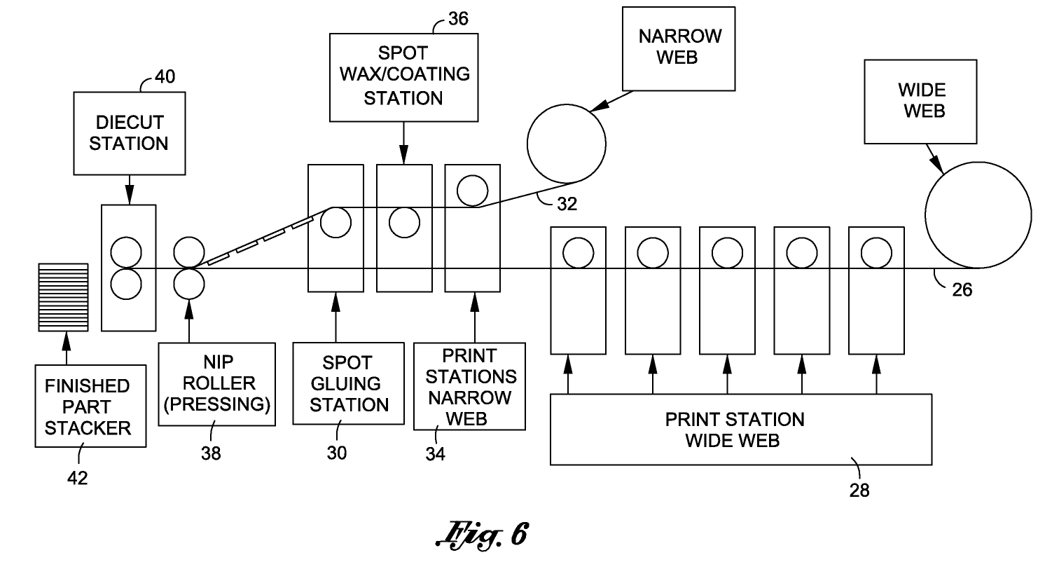

Referring particularity to FIGS. 3 though 5 there is shown the label 4 of the present invention. More particularly, FIG. 3 is a top plan view of the label 4 of the present invention. FIG. 4 is a cross-sectional view of FIG. 3 along the axis AA and FIG. 5 is an exploded view of the layers of the label 4. The label 4 comprises a film 10 having a top exposed surface 12 and opposed lower inward surface 14. The film 10 is a translucent flexible material as is typically used in container labeling such as PET, polypropylene or polyethylene.

The markable region 6 of the label 4 includes a base layer film 16 having a bottom surface 18 and top surface 20. The base layer 16 is preferably printed with a dark ink or coating to provide a visually contrasting region. A region of the film 16 or the entire film 16 may be colored to provide visual contrast. For example, the base layer 16 can be a transparent or semi-transparent film with a dark contrasting printing or a dark contrasting coating applied to either upper surface 20 or lower surface 18. In addition, it is also contemplated by the present invention that the film 16 itself may be a colored film with the pigments distributed throughout the thickness of the film 16. The base layer 16 is preferably a film formed of PET, polypropylene or polyethylene. Further, the base layer 16 can be formed as a contrasting paper layer, or a light paper with contrasting printing. In addition the base layer 16 may include variable imaging for use in applications for use in label game pieces.

The label 4 additionally includes an intermediate layer 22 which is comprised of a deformable substance, preferably a wax. Although the label of the present invention contemplates use of a wax, any other suitable substance which performs a similar function may be utilized such as a ultraviolet (UV) coating, a water base coating, a solvent base coating, multi-part adhesive or hot melt adhesive. The wax 22 is formed in laminar juxtaposition between the upper surface 20 of the base layer 16 and the inward surface 14 of the top layer 10. The deformable substance 22 is sandwiched between elements 10 and 16. An adhesive 24 is formed in a perimeter pattern upon the inward surface 14 of the film 10 to secure the base layer 16 to the upper layer 10. Accordingly, the deformable substance wax layer 22 is sealed between the lower layer 16 and the top layer 10. Although a rectangular perimeter pattern is shown in FIG. 3, the invention additionally contemplates other patterns that would secure the base layer 16 to the layer 10 including, but not limited to, the two vertical sides including adhesive only, or other intermittent patches of adhesive along all four sides, or only two sides.

In operation, pressure is applied to the outer surface 12 of the film 10 over the marking region 6, thereby disrupting the deformable material 22 causing the film 10 to contact or expose the top surface 20 of the base layer 16 thereby creating a visually contrasting area at the point of applied pressure. As such, the user by using a finger or fingernail, can apply pressure to the marking area 6 to provide identifying information to allow the consumer to identify a container. Because the lower layer 16 includes a contrasting dark color to the either transparent or neutral color of the translucent film 10, a mark is created within the markable region 6. Although it is contemplated that the film 10 may be transparent, it can additionally be semi-transparent or semi-opaque, thus allowing the lower layer 16 to be visible at the point of pressure. Additionally, the intermediate deformable layer 22 may be a neutral or semi-transparent color to allow the contrasting visual effect when pressure is applied to the marking region 6. It is additionally contemplated that the top surface 12 of the film 10 may additionally included label printing, however, such label printing over the marking region 6 would be of a semi-opaque nature to allow for an exposure of the lower layer 16 through the disrupted deformable substance 22. In addition the base layer 16 may include variable imaging for use in applications for use in label game pieces and that by applying pressure to the film 10 a user may expose images imprinted on the base layer 16, which may include variable digital images such as game pieces. Variable digital images may allow each label to have unique information on it which can be both numbers or graphical images.

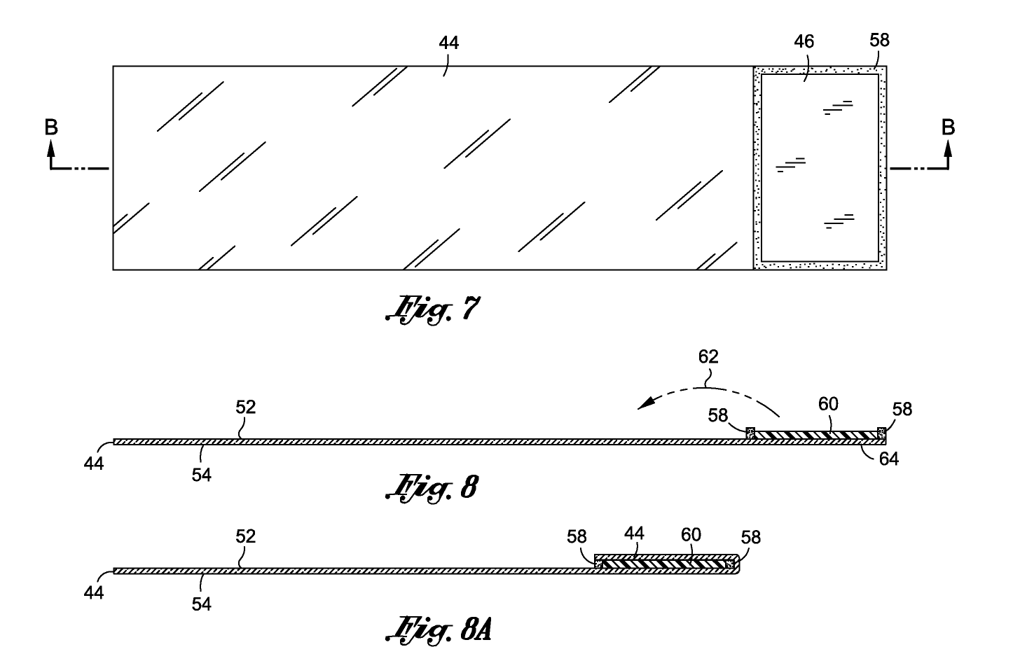

Referring particularly to FIG. 6 there is shown a schematic diagram of a process of manufacturing the label 4 as shown and described in FIGS. 1 through 5. A wide web of film 26 is provided to form the upper layer of the label 4. Print stations 28 apply labeling graphics or other information to the film 26 to the upper exposed surface. A spot gluing station 30 provides a perimeter pattern of adhesive upon the inward surface of the film 26. A narrow web 32 is provided to form the base layer of the label 4. The narrow web 32 is of a height and width of a dimension less than the film 26, however, the present invention contemplates that the both the films 26 and 32 can be of the identical dimensions. A print station 34 applies a visually contrasting region upon the film 32. Preferably, the printing is applied to the upper inward surface of the film 32. Alternatively, when the film 32 is translucent, printing may be applied to the lower surface of the film 32. Furthermore, it is contemplated by the present invention that the film 32 may be comprised of a contrasting colored film, and that printing to achieve the visually contrasting region is not required. Furthermore, the lower layer 32 may be formed of paper, and printing is applied by the printing station 34.

A spot wax coating station 36 is provided to apply a deformable substance upon the inward upper surface of the film 32 over the darker regions of the film 32. The film 26 with the spot glue perimeter patterns meets the base layer film 32 including the darkened regions and the wax coating formed over the darker regions at a NIP roller 38. The NIP roller 38 presses the film 26 and 32 to together such that the wax coating areas of the film 32 meet the wide web film 26 the narrow web secured in place by the pressure of the NIP roller 38 and the adhesive 24 (shown in FIGS. 3-5). The NIP roller could alternatively be replaced by a die station which has a pressing die and only applies pressure to the adhesive area and avoids the wax coating area In a modification to the first method of manufacture, the step of spot gluing can be applied directly on the base layer web of film 32. Also, in a further modification, the step of spot gluing may be eliminated where the upper web of film 26 and the base layer of film 32 are formed from material that is capable of forming a cohesive or static bond when placed in contact without the need of an adhesive. A dye cut station 40 cuts the laminated film into desirable lengths and is deposited into a finished parts stacker 42.

The spot wax coating of station 36 can be applied by a gallus rotary screen as manufactured by Gallus, Inc. of Philadelphia, Pa. While the gallus rotary screen is preferred, it is contemplated that other rotary screen devices may be utilized such as a Stork RSI print module as provided by Stork Prints America, Inc. of Charlotte, of N.C. The wax coating of station 36 may also be hot melt applied by a rotary screen or a UV coating applied by a screen device and then activated by a UV light immediately after application. The wax coating can also be applied by a therma-wax transfer printer digital unit. The wax coating may be food grade such as Imerzol OPE-35N as produced by Syntec Additive Co., Ltd. of Nontavuree, Thailand and can be mixed with a solvent or water based carrier and flack off through a dryer before a glue application is applied. Although the present invention contemplate the Syntec food grade wax, other type of wax materials are contemplated.

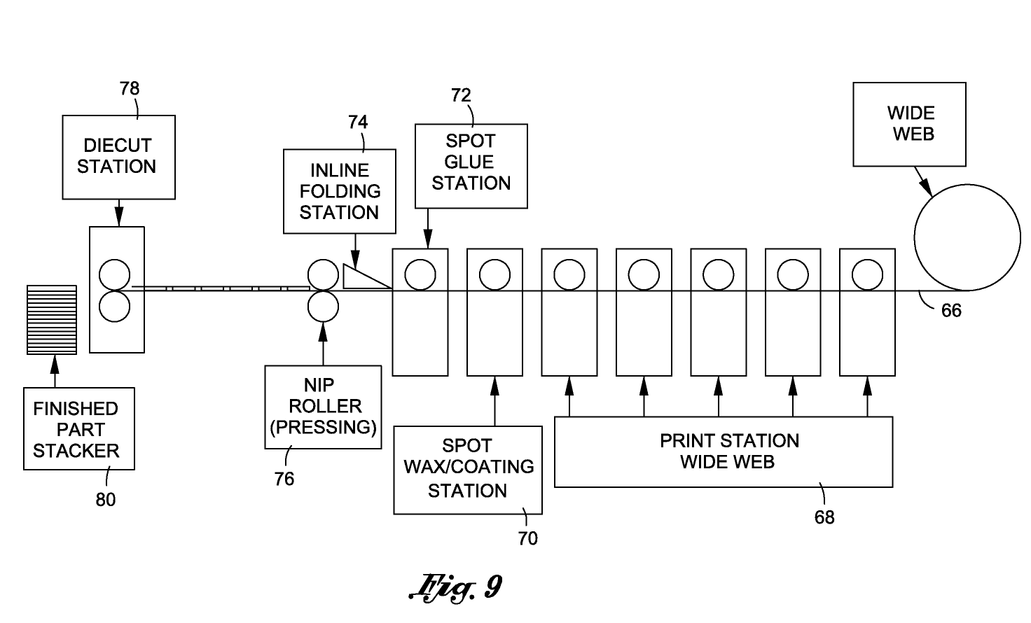

Referring particularly to FIG. 7, 8 and 8a there is shown an alternative embodiment of the method of producing the label of the present invention. In the embodiment shown in FIGS. 7, 8 and 8a the film 44 is shown with a marking region 46. FIG. 8 shows a cross-section of the film 44 along lines BB of FIG. 7. The film 44 includes a lower inner layer 52 and an upper exposed layer 54. An adhesive 58 is formed upon the inward surface 52 of the film 44. A deformable substance, namely wax is coated upon the inner surface 52 of the film 44 with the boundaries of the adhesive 58. A contrasting color print coating is applied to the surface 52 of the film 44 such that it provides a visually contrasting color to that of the wax coating 60. The wax coating 60 applied between the spot of the adhesives 58 is applied over atop a region 64 including the visually contrasting area. The film 44 is folded in the direction of arrow 62 such that the spot adhesive 58 contacts the inner surface 52 of the film 44 to laminate the wax material 60 between the folded layers of film 44. The alternative embodiment as shown in FIG. 7, 8 and 8a can be produced on a single web of film and does not require the additional manufacturing step of including a second film.

Referring particularly to FIG. 9 there is shown a diagram of the process of forming the label 44 as shown in FIGS. 7, 8 and 8a. A wide web material 66 such as a translucent film is provided and is imprinted with indentifying information and label graphics as well as dark contrasting regions upon the web 66. A spot wax coating station 70 applies a deformable substance such as a wax to the film 66 over the contrasting images imprinted upon the film 66, which may include variably printed digital images or numbers. The spot coating is applied to the film as discussed with respect to FIG. 6. A spot glue station 72 provides perimeter gluing pattern such that is shown as item 58 in FIGS. 7, 8 and 8a. Although it is contemplated that the glue would be formed as a perimeter around the wax 60, it is additionally contemplated that the glue can be spotted on two sides of the wax 60 rather than all four sides or in intermittent patterns in several configurations. An inline folding station 74 creases the film as exemplified in FIG. 7 and folds over the film 66 to secure the adhesive 58 to the inner surface 52 of the film 44 and the folded section is pressed by a NIP roller 76 and therefore is fed to a dye cut station 78 where it is cut to desirable lengths and stacked by a finisher part stacker 80. In a modification of the of the alternative method of manufacture as shown in FIG. 9, the step of applying a spot adhesive may be eliminated where the single web of film 66 is formed from material that forms a cohesive or static bond when the material is folded onto itself and thus an adhesive is not required.

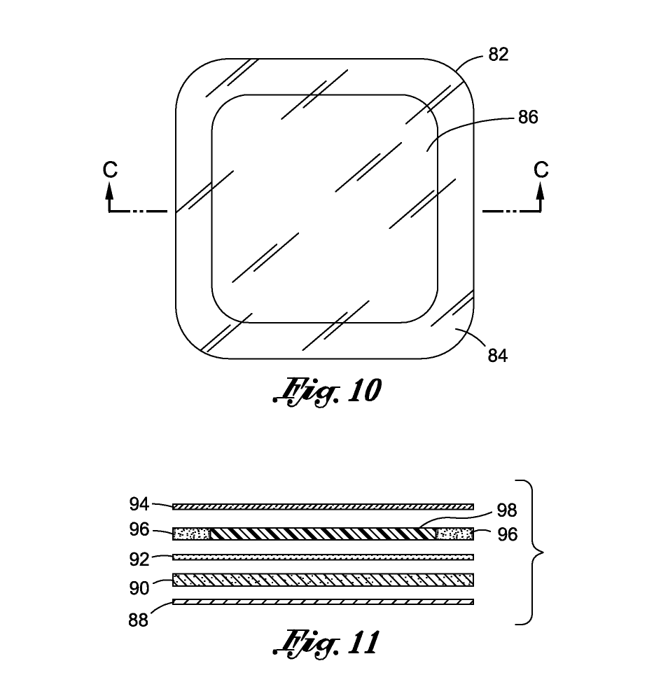

Now referring particularly to FIGS. 10 and 11, there is shown a print pressure sensitive label construction 82 having a pressure sensitive adhesive area 84 and a writable area 86. The writable area 86 is formed consistent with the layered construction shown in FIG. 5, but with the addition of a release liner and a pressure sensitive adhesive.

Referring particularly to FIG. 11 there is shown a cross-sectional exploded view of the label 82 along the C-C axis of FIG. 10. The construction includes a release liner 88 and a pressure sensitive adhesive 90. In operation, the user will peel away the release liner 88 and apply the pressure sensitive adhesive 90 to a surface or alternatively the label could be machine applied to a beverage container from a roll of labels. Although it is contemplated that the label 82 would be applied to a beverage container, it is contemplated that the label would be applied to any surface capable of receiving the pressure sensitive adhesive 90. The label 82 includes a base layer 92 having a contrasting coating or color. In addition the base layer 92 may include variable imaging for use in applications for use in label game pieces. A translucent upper layer 94 is provided in this exploded view to attach to the base layer 92 to the adhesive 96 laminating an intermediate layer 98 of wax between the film 94 and base 92.

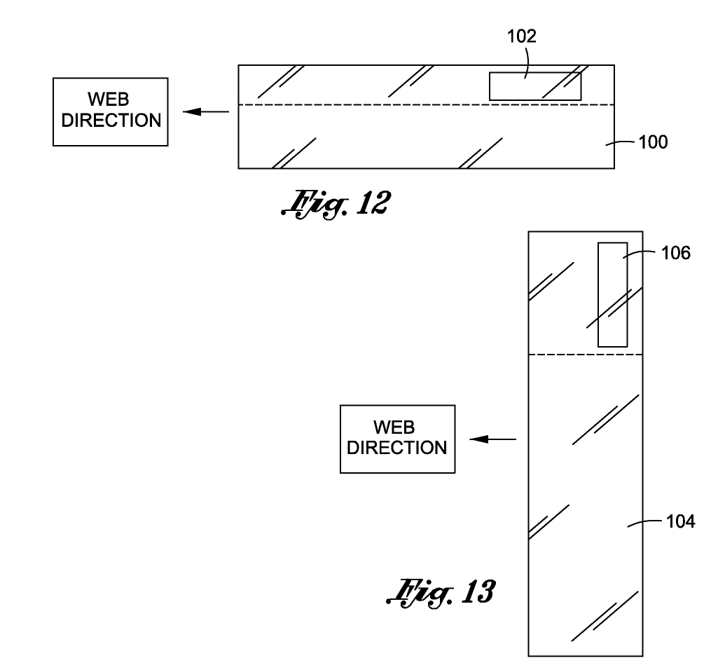

Referring particularly to FIGS. 12 and 13 there is shown embodiments of different manufacturing techniques to produce the label of the present invention using a folding technique depending on whether the label is created with a long narrow web or a thicker web. Referring to FIG. 12 there is shown a label 100 with the marking region 102 formed at a particular location on the label 100. The dotted lines represents the edge of the folded area of the label. The label 100 is shown produced in a long direction of the label which is desirable if the manufacturing process requires a rewinding to a roll for automatic label application to beverage bottles. Referring to FIG. 13 there is shown a label 104 with the marking region 106 produced in the short direction of the label which is desirable if using cut label for automation using cut label application to beverage bottles. The dotted line represents the edge of the folded area of the label.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A container label capable of being marked without the use of a writing device, said label comprising;
a. An upper layer comprising a translucent film, said film having an upper exposed surface and an opposed lower inward surface;
b. A base layer comprising a film having opposed upper and lower surfaces, said base layer film having a visually contrasting region;
c. An intermediate layer comprising a deformable covering material in laminar juxtaposition between at least a portion of the lower inward surface of the upper layer film and at least a portion of the visually contrasting region of base layer film; and
d. Wherein application of pressure upon the exposed surface upper layer film disrupts the intermediate covering material to visually expose the contrasting region of the base layer film at the point of applied pressure.

2. The label of claim 1 wherein the translucent film of the upper layer is transparent.

3. The label of claim 1 wherein the translucent film of the upper layer is semi-transparent.

4. The label of claim 1 where in the translucent film of the upper layer is semi-opaque.

5. The label of claim 1 wherein said deformable material is wax.

6. The label of claim 1 wherein said deformable material is a UV coating.

7. The label of claim 1 wherein said deformable material is water based coating.

8. The label of claim 1 wherein said deformable material is solvent based coating.

9. The label of claim 1 wherein said deformable material is a multipart adhesive.

10. The label of claim 1 wherein said deformable material is a hot melt adhesive.

11. The label of claim 1 wherein said base layer film includes a contrasting print coating applied to the upper surface of said base layer film to form the contrasting region.

12. The label of claim 1 wherein said base layer film is translucent and includes a contrasting print coating applied to the lower surface of the base layer film to form the contrasting region.

13. The label of claim 1 wherein the base layer film is colored to form the contrasting region.

14. The label of claim 1 wherein the base layer film includes variable digital images.

15. The label of claim 1 wherein the lower inward surface of the upper layer of translucent film and the upper surface of said base layer contact and are adheredly fixed around the deformable covering material.

16. The label of claim 15 wherein the inward surface of the upper layer of film and the upper surface of the base layer are adheredly fixed by an adhesive material.

17. The label of claim 15 wherein the inward surface of the upper layer of film and the upper surface of the base layer are adheredly fixed by a cohesive bond formed by the contact of the film surfaces.

18. The label of claim 15 wherein the inward surface of the upper layer of film and the upper surface of the base layer are adheredly fixed by static attraction.

19. A container label capable of being marked without the use of a writing device, said label comprising;
a. An upper layer comprising a translucent film, said film having an upper exposed surface and an opposed lower inward surface;
b. A base layer comprising a generally planar element having opposed upper and lower surfaces, the upper surface of said planar element having a visually contrasting region;
c. An intermediate layer comprising a deformable covering material in laminar juxtaposition between at least a portion of the lower inward surface of the upper layer film and at least a portion of visually contrasting region of the upper surface of the planar element of the base layer; and
d. Wherein application of pressure upon the exposed surface of the upper layer film disrupts the intermediate covering material to visually expose the contrasting region of the base layer planar element at the point of applied pressure.

20. The label of claim 19 wherein the translucent film of the upper layer is transparent.

21. The label of claim 19 wherein the translucent film of the upper layer is semi-transparent.

22. The label of claim 19 where in the translucent film of the upper layer is semi-opaque.

23. The label of claim 19 wherein said deformable material is wax.

24. The label of claim 19 wherein said deformable material is a UV coating.

25. The label of claim 19 wherein said deformable material is water based coating.

26. The label of claim 19 wherein said deformable material is solvent based coating.

27. The label of claim 19 wherein said deformable material is a multipart adhesive.

28. The label of claim 19 wherein said deformable material is a hot melt adhesive.

29. The label of claim 19 wherein said base layer film includes a contrasting print coating applied to the upper surface of said base layer planar element to form the contrasting region.

30. The label of claim 19 wherein said base layer planar element a colored material.

31. The label of claim 19 wherein said base layer planer element is paper.

32. The label of claim 19 wherein the base layer film includes variable digital images.

33. The label of claim 19 wherein the lower inward surface of the upper layer of translucent film and the upper surface of said base layer contact and are adheredly fixed around the deformable covering material.

34. The label of claim 33 wherein the inward surface of the upper layer of film and the upper surface of the base layer are adheredly fixed by an adhesive material.

35. The label of claim 33 wherein the inward surface of the upper layer of film and the upper surface of the base layer are adheredly fixed by a cohesive bond formed by the contact of the film surfaces.

36. The label of claim 33 wherein the inward surface of the upper layer of film and the upper surface of the base layer are adheredly fixed by static attraction.

37. A method of fabricating a container label capable of being marked without the use of a writing device, said steps comprising.
a. providing an upper layer web of translucent film having an upper exposed surface and a lower inward surface;
b. spot gluing a perimeter pattern upon the inward surface of the upper layer web of film;
c. providing a base layer web of film, said base layer film having upper and lower surfaces;
d. printing a visually contrasting region upon the upper surface of the base layer film;
e. spot coating at least a portion of the visually contrasting region of the upper surface of the base layer film with a deformable substance;
f. placing the inward surface of the upper layer film against the upper surface of the base layer film such that the spot coating of deformable substance is laminated within the spot glue perimeter pattern.

38. The method of claim 37 wherein the lower surface of said base layer film includes a pressure sensitive adhesive and removable liner.

39. A method of fabricating a container label capable of being marked without the use of a writing device, said steps comprising.
a. providing an upper layer web of translucent film having an upper exposed surface and a lower inward surface;
b. spot gluing a perimeter pattern upon the inward surface of the upper layer web of film;
c. providing a base layer web of film, said base layer film having upper and lower surfaces;
d. spot coating at least a portion of the visually contrasting region of the upper surface of the base layer film with a deformable substance;
e. placing the inward surface of the upper layer film against the upper surface of the base layer film such that the spot coating of deformable substance is laminated within the spot glue perimeter pattern.

40. The method of claim 39 wherein the lower surface of said base layer film includes a pressure sensitive adhesive and removable liner.

41. A method of fabricating a container label capable of being marked without the use of a writing device, said steps comprising.
a. providing a of web of translucent film having an upper exposed surface and a lower inward surface;
b. printing a visually contrasting region upon the lower inward surface of the film;
c. spot coating at least a portion of the visually contrasting region of the inward surface of the film with a deformable substance;
d. spot gluing a perimeter pattern on the inward surface of the film around the deformable substance coating;
e. folding the film to have the lower inward surface with the spot coating of deformable substance meet a portion of the film without such that the spot coating of deformable substance is laminated within the spot glue perimeter pattern.

42. A method of fabricating a container label capable of being marked without the use of a writing device, said steps comprising.
a. providing an upper layer web of translucent film having an upper exposed surface and a lower inward surface;
b. providing a base layer web of film, said base layer film having upper and lower surfaces;
c. spot coating at least a portion of the visually contrasting region of the upper surface of the base layer film with a deformable substance;
d. placing the inward surface of the upper layer film against the upper surface of the base layer film such that the spot coating of deformable substance is laminated within the spot glue perimeter pattern.
e. adherlely fixing the lower inward surface of the upper layer film to the upper surface of the base layer film around the coating of deformable surface.

43. The method of claim 42 wherein the lower surface of said base layer film includes a pressure sensitive adhesive and removable liner.

44. The method of claim 42 wherein lower inward surface of the upper layer film and the upper surface of the base layer film are adheredly affixed by an adhesive.

45. The method of claim 42 wherein lower inward surface of the upper layer film and the upper surface of the base layer film are adheredly affixed a cohesive bond formed by the contact of the film surfaces.

46. The method of claim 42 wherein lower inward surface of the upper layer film and the upper surface of the base layer film are adheredly affixed by a static bond.
